(19) United States
(12) Patent Application Publication
(10) Pub. No.: US 2025/0289342 A1
(43) Pub. Date: Sep. 18, 2025

(54) LOGISTICAL SYSTEM FOR CHARGING ELECTRICAL VEHICLES

(71) Applicant: Itron, Inc., Liberty Lake, WA (US)

(72) Inventors: Ajaraj Bagalkoti, Bangalore (IN); Ratnavel Nambirajan Subramanian, Bengaluru (IN)

(21) Appl. No.: 18/602,794

(22) Filed: Mar. 12, 2024

(51) Int. Cl. B60L 53/67; B60L 53/57; B60L 53/62; B60L 53/64; B60L 53/66

(52) U.S. Cl. CPC B60L 53/67; B60L 53/57; B60L 53/62; B60L 53/64; B60L 53/665; B60L 2240/622; B60L 2240/80; B60L 2260/52

(57) ABSTRACT

The structure and operation of a logistical system for charging electrical vehicles (EVs) are described. The logistical system may include synergistically interacting hardware and software components on a computer of a charging service, a plurality of EVs, and a plurality of charging stations. Charge information describing conditions of a battery of an EV, and EV location information, may be sent to the charging service computer. An application operating on the EV and/or driver's mobile device may receive data from the charging service, which may include a location of a charging station capable of charging the EV and an estimated charging time and/or cost for the battery charging. Charging stations, in communication with the charging service, provide information that assists the charging service to select an appropriate charging station. Mobile charging-vehicles may be directed to particularly needed locations by the charging service, and may charge electrically assisted bicycles and other vehicles.

### BACKGROUND

As electric vehicles (EVs) become more common, there is a need for more charging stations. Moreover, since the charging infrastructure is not fully developed, considerable concern is present among EV owners (both actual and prospective) regarding charging availability, costs, locations, timing, connector types, etc. The concerns and needs are related to vehicles including private and corporate automobiles and trucks, as well as bicycles, scooters, and others.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a block diagram showing an example of a logistical system for charging electrical vehicles (EVs).

FIG. 2 is a block diagram showing an example application for a logistical system for charging EVs, wherein the application is operable on an EV, a mobile device of an EV user/driver, or other device.

FIG. 3 is a block diagram showing an example application for a logistical system for EV charging, wherein the application is operable on a charging service, data center, computing device, cloud-based website, etc.

FIG. 4 is a block diagram showing an example application for a logistical system for EV charging, wherein the application is operable on a charging station.

FIG. 5 is a flow diagram showing example operation of an application operable on an EV, that is configured to monitor conditions on an EV.

FIG. 6 is a flow diagram showing example operation of an application operable on an EV, that is configured to request and receive a battery-charging appointment for an EV.

FIG. 7 is a flow diagram showing example operation of an application operable on an EV, that is configured to request a battery-charging appointment for an EV based on a specific location or a location within a specified area.

FIG. 8 is a flow diagram showing example operation of an application operable on an EV, that is configured to receive and respond to a request for payment and/or payment information.

FIG. 9 is a flow diagram showing example operation of an application operable on a charging service that is configured to obtain information from EVs and/or EV drivers, and to obtain information from EV charging stations, and to use the information to coordinate the needs of EV battery-charging with the availability of EV charging systems, within a logistical system for EV charging.

FIG. 10 is a flow diagram showing example operation of an application operable on a charging service that is configured to select a charging station that would result in a shortest time until the charge was completed.

FIG. 11 is a flow diagram showing example operation of an application operable on a charging service that is configured to select a charging station that would result in the lowest cost to charge.

FIG. 12 is a flow diagram showing example operation of an application operable on a charging service that is configured to obtain information from a prospective charging station.

FIG. 13 is a flow diagram showing example operation of an application operable on a charging service that is configured to manage aspects of the operation of a charging station.

FIG. 14 is a flow diagram showing example operation of an application operable on a charging service that is configured to manage aspects of charging station selection.

FIG. 15 is a flow diagram showing example operation of an application operable on a charging service that is configured to manage a mobile charging-vehicle.

FIG. 16 is a flow diagram showing example operation of an application operable on a mobile charging-vehicle.

FIG. 17 is a flow diagram showing example operation of an application operable on an EV charging station.

### DETAILED DESCRIPTION

### Overview

As noted above, the charging infrastructure is not fully developed, and there is considerable concern among EV owners (both actual and prospective) regarding charging availability, costs, locations, timing, connector types, etc. At the same time, many private charging stations are currently underutilized, only being utilized by their owners to charge vehicles a small percentage of the time (e.g., overnight).

This application describes structure and operation of a logistical system for charging electrical vehicles (EVs) that increases utilization of existing charging stations and also increases the incentive to invest in building and installing additional charging stations. In an example, the logistical system may include synergistically interacting hardware and software components located on: computer(s) of a charging service; a plurality of EVs and/or mobile devices of EV users; and/or a plurality of EV charging stations and/or mobile devices of charging station owner(s)/manager(s). “Mobile devices” include at least: cellphones; tablets; wearable devices (e.g., watches, rings, headsets, video visors and/or eyeglasses, etc.); or other portable computing devices. In example operation, battery charge information describing conditions of a battery of an EV, and EV location information, may be sent by the EV or a mobile device of an EV user to one or more charging service (CS) computing device(s). The charging service may include, and/or be operated on, a cloud computing platform, which may include additionally or alternatively, multiple distributed computing devices (possibly with no central computer). A plurality of charging stations, also in communication with the CS computing device(s), may provide information such as: their available charging timeslots; available charging hardware (connector types, etc.); charging station locations; local traffic; charging costs (e.g., current or estimated future price of electricity, any service or access charges to use the charger, etc.) and other information if available and/or helpful. In some examples, the charging stations may be in communication directly or indirectly (e.g., via a smart utility meter or local network hub device) with the CS computing device(s). Using information from the plurality of EVs and the plurality of charging stations, the charging service matches the EVs with appropriate charging stations. In an example, the charging service sends invitations for appointments to EVs, suggesting the addresses of nearby charging stations with the capacity to do the charging. Such invitations for appointments may be received by an application operating on the EV and/or driver's mobile device, which may include location(s) of charging station(s) capable of charging the EV and estimated charging time(s) and/or cost(s) for the battery charging. In a further example, one or more charging trucks may be directed by the charging service to locations having particular need, and may include one or more generators, solar arrays, batteries, capacitors, or other electricity generation and/or storage devices to charge EVs, such as electrically-assisted bicycles, etc.

While EVs typically store energy in batteries (and this document typically refers to batteries), EVs may store their electricity in batteries, capacitors, fuel cells, or any other energy storage media. The techniques discussed herein may be applied to any such storage devices.

### Example System and Techniques

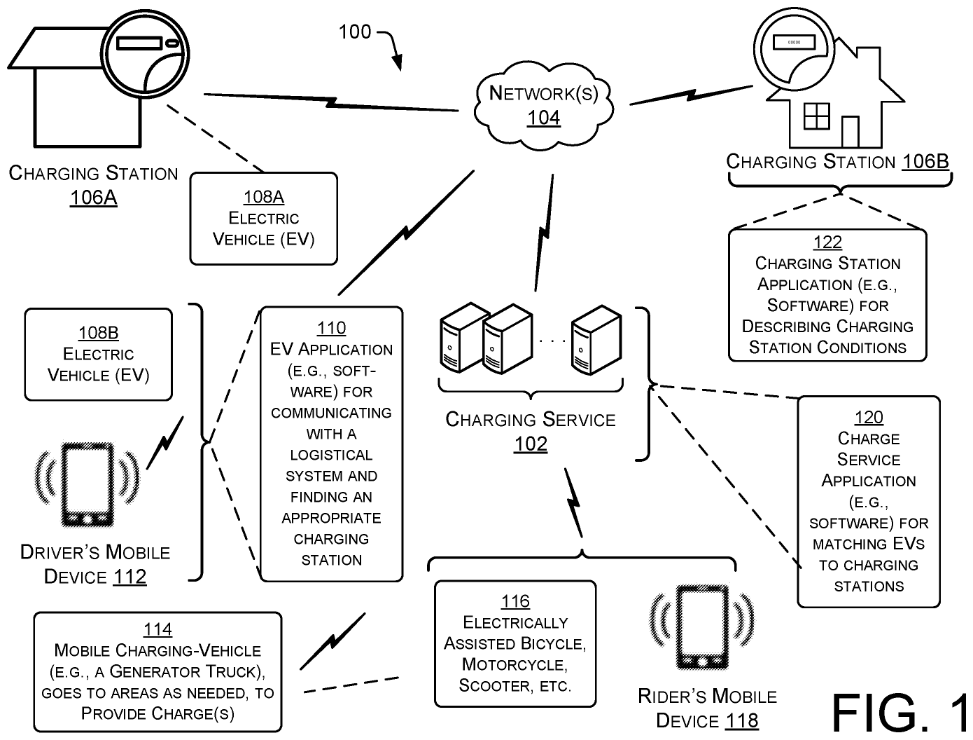

FIG. 1 shows an example of a logistical system 100 for electrical vehicle (EV) charging. The logistical system 100 addresses the shortage of charging stations by utilizing the many private charging stations that are currently underutilized, only being utilized by their owners to charge vehicles a small percentage of the time. In the example, a charging service 102 communicates over one or more networks 104, such as the internet, private networks, cellphone networks, etc. The charging service 102 communicates with one or more charging stations (e.g., charging stations 106A, 106B), which are configured to charge EVs 108A, 108B. As used herein EVs include electric or electrically-assisted cars, trucks, buses, bicycles, scooters, aircraft, watercraft, or any other vehicle that is at least partially powered by electricity.

When communicating with a charging station 106, the charging service 102 may communicate with a computing device of the charging station. In an example wherein the charging station 106 is a small business, such as a homeowner renting out a vehicle charging station of the home, the charging service may communicate with a mobile device of the homeowner.

The charging service 102 may communicate with an application 110 that operates on a computing device of the EV 108 and/or an application that operates on the mobile device 112 of the driver of the EV. In some examples, the application 110 may operate on or be in communication with the vehicle's entertainment system. Such entertainment systems may provide radio, satellite radio, global positioning system (GPS) mapping and navigation systems, etc. They may also support the operation of applications, such as the application 110, which is configured for communication with the charging service 102.

In an example, the charging service 102 may also communicate with a mobile charging-vehicle 114, such as a generator truck. The mobile charging-vehicle 114 may have one or more of a fuel supply (e.g., diesel, gasoline, hydrogen, etc.), an electricity generation source (a fuel powered generator, solar panels, etc.), and/or an energy storage device (e.g., one or more large batteries, capacitors, fuel cells, etc.). In one example, the mobile charging-vehicle could be another EV having sufficient charge to transfer to another EV. In the example, the mobile charging-vehicle 114 is shown charging an electrically assisted bicycle 116. In some implementations, the electrically-assisted bicycle 116 or a rider's mobile device 118 (i.e., a mobile device of the rider of the electrically assisted bicycle 116) may have computing hardware to operate the application 110 (or a variation thereof) to communicate with the charging service application 120.

In the logistical system 100, a plurality of EVs 108 and/or drivers' mobile devices 112 operate a respective plurality of EV applications 110. Each EV application 110 gathers data from the EV (e.g., battery charge condition and/or EV location) for transmission to the charging service 102. The EV application 110 also receives data from the charging service 102 (e.g., a location of a suitable charging station, a charging appointment time, and/or a charging cost).

The charging service 102 may operate a charging service application 120. The charging service application 120 gathers data from a plurality of EV applications 110 associated with a respective plurality of EVs 108. Additionally, the charging service application 120 gathers data from a plurality of charging station applications 122 associated with a respective plurality of charging stations 106. In operation, the charging service application 120 maintains a database of information including: available charging resources (e.g., timeslots, parking spots, and charging devices) at the plurality of charging stations 106; locations of the charging stations 106; battery-charging requirements of each of a plurality of EVs 108; and locations of each of the plurality of EVs. Additionally, the charging service application 120 utilizes an algorithm to match EVs with charging stations. The algorithm may utilize techniques including: artificial intelligence; linear programming; operations research; and other techniques to match the EVs with appropriate charging stations. The algorithm may be operated in an iterative manner, as the locations of EVs change and as the charge (i.e., the percentage of charge capacity, the actual energy, or other measure) on batteries changes (in both moving EVs and charging EVs). The algorithm may also predict the future locations of the EVs and traffic conditions, to forecast the charging demand of one or more charging station locations more accurately. The algorithm may also direct the location and/or movement of one or more mobile charging-vehicles 114. Such movements and locations may be selected, performed, and then utilized to obtain better results from the algorithm.

The charging stations 106 operate respective charging station applications 122. Each of the charging station applications 122 may maintain a database of information including: timeslots; parking spots; EV appointments, EV types and/or requirements; and/or charging device types; etc. The charging station applications 122 communicate data from the database to the charging service application 120 and/or EV applications 110. The charging station applications 122 receive appointment requests from, and make appointments with, the charging service application 120 and/or the EV applications 110.

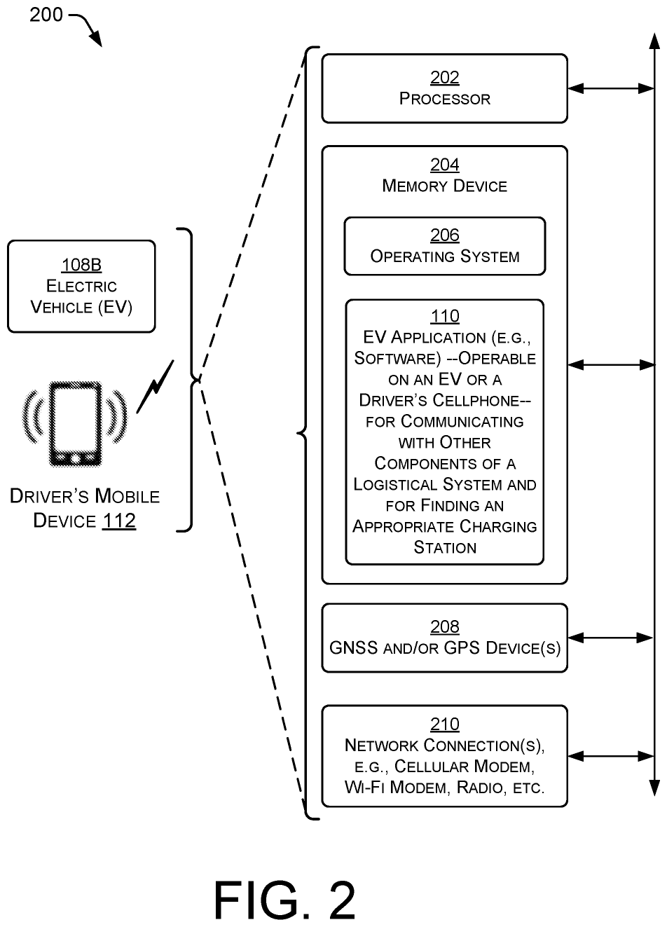

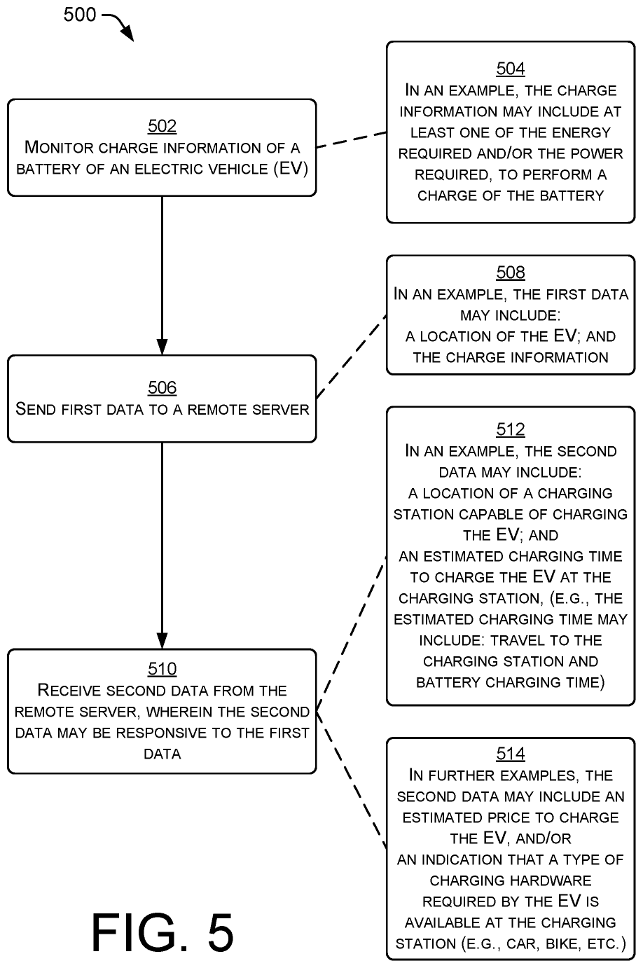

FIG. 2 shows an example electric vehicle subsystem 200 of a logistical system (e.g., the logistical system 100 of FIG. 1) for charging EVs. The electric vehicle subsystem 200 is operable on devices of an EV (e.g., the entertainment system), a mobile device of a user/driver, and/or other computing device. A processor 202 is in communication with a memory device 204, which contains an operating system 206. The EV application 110 includes software stored on the memory device 204 that is executable by the processor 202. In an example, the EV application 110 is configured to: monitor battery conditions; monitor a geographic location (and/or a path of travel or destination) of the EV with which it is associated; send data to the charging service 102; and receive data from the charging service (e.g., an appropriate charging station at which the EV can be charged). In examples, the EV application 110 may be configured to perform some or all of the techniques described by FIGS. 5 through 8, and to perform other techniques as described and/or suggested by this document.

One or more global navigation satellite systems (GNSS) devices 208, such as global positioning system (GPS) devices, may be accessed by the processor. Data from these devices can determine the location of the EV using the application 110. The location data is additionally relevant to determine EV course of travel, future locations, distances to respective charging stations, potential arrival times at different charging stations, etc.

One or more network connections 210 may include radios generally, including Wi-Fi modem(s), cellular modems (e.g., mobile devices and/or circuitry), private networks (radio, fiber optics, etc.), and others. The network connections 210 may connect the EV application 110 to the internet, and provide two-way communication with the charging service 102 and associated charging service application 120, charging stations 106 and associated charging station applications 122), and other internet and/or internet of things locations.

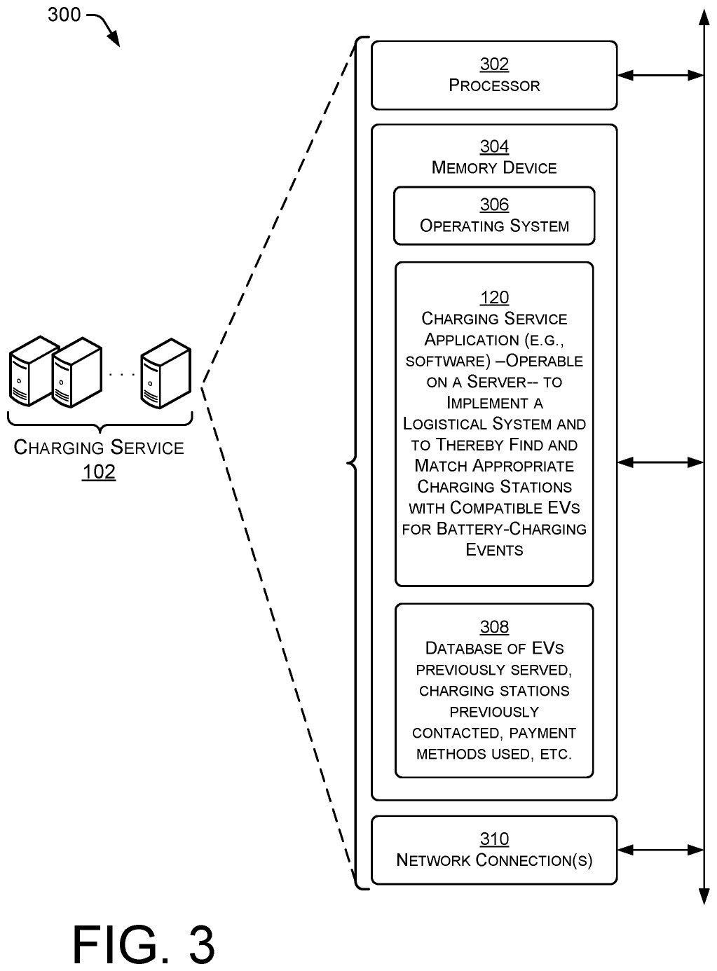

FIG. 3 shows an example charging service subsystem 300 of the logistical system 100 for EV charging, that is operable on a computing device, a data center, a cloud-based website, a distributed computing environment, etc. A processor 302 is in communication with a memory device 304, which contains an operating system 306. The charging service application 120 includes software stored on the memory device 304 that is executable by the processor 302.

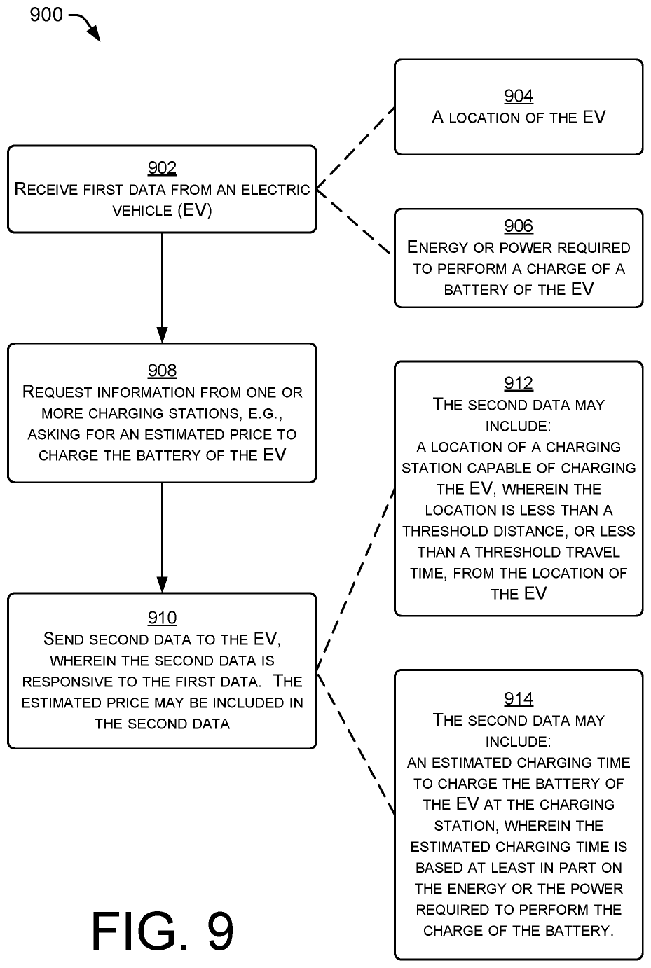

The charging service application 120 is configured to perform one or more of: receiving data from EVs; receiving data from charging stations; building and maintaining database 308 with the received data; operating an algorithm to match EVs with charging stations; making or suggesting appointments for EVs with charging stations; and interfacing with payment entities, such as banks, money transfer apps, credit card companies, etc. In examples, the charging service application 120 may be configured to perform some or all of the techniques described by FIGS. 9 through 14, and perform other techniques as described and/or suggested by this document.

Network connections 310 may be similar to network connections 210.

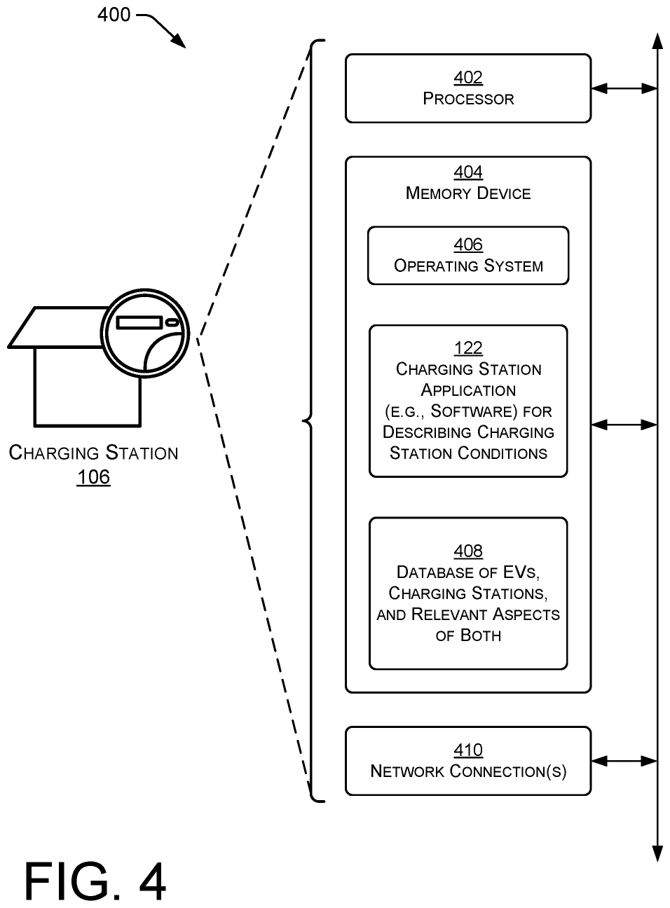

FIG. 4 shows an example charging station subsystem 400 of the logistical system 100 for EV charging, which is operable on a charging station. A processor 402 is in communication with a memory device 404, which contains an operating system 406. The charging station application 122 includes software stored on the memory device 404 that is executable by the processor 402.

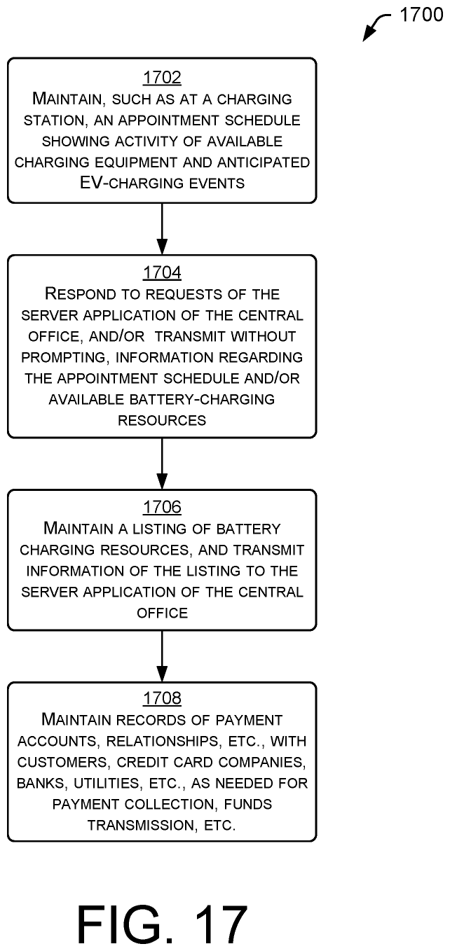

The charging station application 122 is configured to perform one or more of: sending data, such as the availability of charging equipment and timeslots, to the charging service application 120; receiving data, such as appointments with EVs for battery charging, from the charging service application 120; and maintaining a database of available charging stations, appointments with EVs, and related matters. The charging station application 122 may also be configured to maintain a database 408 of information regarding EVs previously served, payment methods used, and other data as needed. In examples, the charging station application 122 may be configured to perform some or all of the techniques described by FIG. 17, and perform other techniques as described and/or suggested by this document.

Network connections 410 may be similar to network connections 210.

### Example Methods

In some examples, the techniques discussed herein may be implemented by one more processors accessing software defined on one or more memory devices. The processor(s) and memory device(s) may be located on an electricity meter and/or a cloud-based computing device (e.g., a computing device of a utility company). If the functionality is distributed, software may reside on both the electricity meter and the computing device.

In other examples of the techniques discussed herein, the methods of operation may be performed by one or more application specific integrated circuits (ASIC) or may be performed by a general-purpose processor utilizing software defined in computer readable media. In the examples and techniques discussed herein, the memory devices (e.g., devices 204, 304, 404) may comprise computer-readable media and may take the form of volatile memory, such as random-access memory (RAM) and/or non-volatile memory, such as read only memory (ROM) or flash RAM. Computer-readable media devices include volatile and non-volatile, removable, and non-removable media implemented in any method or technology for storage of information such as computer-readable instructions, data structures, program modules, or other data for execution by one or more processors of a computing device. Examples of computer-readable media include, but are not limited to, phase-change memory (PRAM), static random-access memory (SRAM), dynamic random-access memory (DRAM), other types of random access memory (RAM), read-only memory (ROM), electrically erasable programmable read-only memory (EEPROM), programmable read-only memory (PROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media includes non-transitory media. Computer-readable media does not include transitory media, such as modulated data signals and carrier waves, and/or other information-containing signals.

### Example Electric Vehicle Operations

FIG. 5 shows example operation 500 of a system, device, and/or software application to monitor conditions on an EV and to communicate with other systems and devices of a logistical system for EV charging. In an example, the operation 500 may be performed by the EV application 110 of FIG. 1, which may execute by operation of a computing device of the EV 108B (e.g., an app running on the entertainment system of the EV) and/or the driver's mobile device 112.

At block 502, charge information of a battery of an EV is monitored. In an example shown at block 504, the charge information may include at least one of the approximate energy required and/or the approximate power required, to perform a charge of the battery.

At block 506, first data is sent to a remote computing device. In the example of block 508, the first data may include: a location of the EV; and the charge information.

At block 510, second data is received from the remote computing device. The second data may be responsive to the first data. In the example shown at block 512, the second data may include: a location of a charging station capable of charging the EV; and an estimated charging time to charge the EV at the charging station, (e.g., the estimated charging time may include: travel to the charging station and battery charging time). In the example shown at block 514, the second data may include: an estimated price to charge the EV; and/or an indication that a type of charging hardware required by the EV is available at the charging station (e.g., car, bike, etc.).

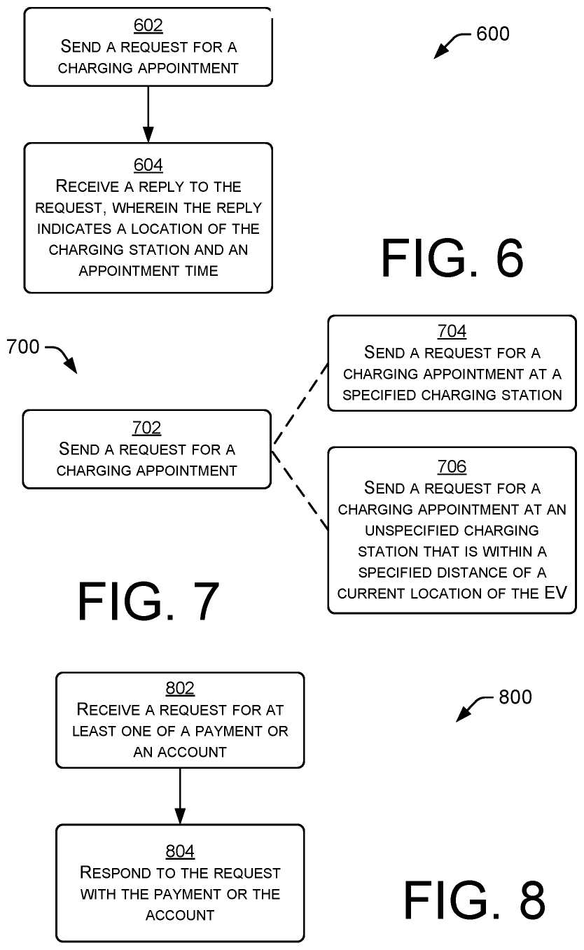

FIG. 6 shows example operation 600 of a system, device, and/or software application to request and receive a battery-charging appointment for an EV. In the example, the operation 600 may be performed by the EV application 110 of FIG. 1, which may execute by operation of a computing device of the EV 108B and/or the driver's mobile device 112. At block 602, a request is sent for a charging appointment. In some examples, the request is sent directly to a charging station (e.g., a charging station that has been used previously). In other examples, the request is sent to the charging service 102, which looks for an appropriate charging station. At block 604, a reply to the request is received. In an example, the reply indicates a location of the charging station and an appointment time. The reply may be sent by either a specific charging station 106 or the charging service 102.

FIG. 7 shows example operation 700 of a system, device, and/or software application that requests a battery-charging appointment for an EV based on a specific location or a location within a specified area. In the example, the operation 700 may be performed by the EV application 110 of FIG. 1, which may execute by operation of a computing device of the EV 108B and/or the driver's mobile device 112. At block 702, a request is sent for a charging appointment. In the example of block 704, the request is for a charging appointment at a specified charging station. In the alternative example of block 706, a request is for a charging appointment at an unspecified charging station that is within a specified (or default) distance of a current location of the EV. In the example of block 706, the default distance may be a function of the remaining EV battery charge, i.e., a shorter default distance if the battery is more nearly discharged, and a longer default distance if the battery is less nearly discharged.

FIG. 8 shows example operation 800 of a system, device, and/or software application to receive and respond to a request for payment and/or payment information. In the example, the operation 800 may be performed by the EV application 110 of FIG. 1, which may execute by operation of a computing device of the EV 108B and/or the driver's mobile device 112. At block 802, a request is received for at least one of a payment or an account. At block 804, a response is made to the request, such as with the payment or the account.

### Example Charging Service Application Operations

FIG. 9 is a flow diagram showing example operation 900 of a system, device, and/or software application, within a logistical system 100 for EV charging. The example operation 900 may be performed by the charging service application 120 of FIG. 1, which may execute by operation of the charging service 102. The example operation 900 functions to: obtain information from EVs and/or EV drivers; obtain information from EV charging stations; and use the information to coordinate the needs of EV battery-charging with the availability of EV charging systems. At block 902, first data is received from an EV. In a first example, shown at block 904, the first data includes a location of the EV. Additionally or alternatively, at block 906, the first data includes a value of the energy or power required to perform a charge of a battery of the EV. At block 908, a first message is sent to the charging station asking for an estimated price to charge the battery of the EV. At block 910, second data is sent to the EV, wherein the second data is responsive to the first data. The estimated price of the EV charging may be included in the second data. At block 912, in a first example of the data sent to the EV, a location of a charging station capable of charging the EV is sent to the EV. The location may be less than a threshold distance, or less than a threshold travel time, from the current location of the EV. Additionally or alternatively, at block 914, the second data may include an estimated charging time to charge the battery of the EV at the charging station. The estimated charging time may be based at least in part on the energy or the power required to perform the charge of the battery.

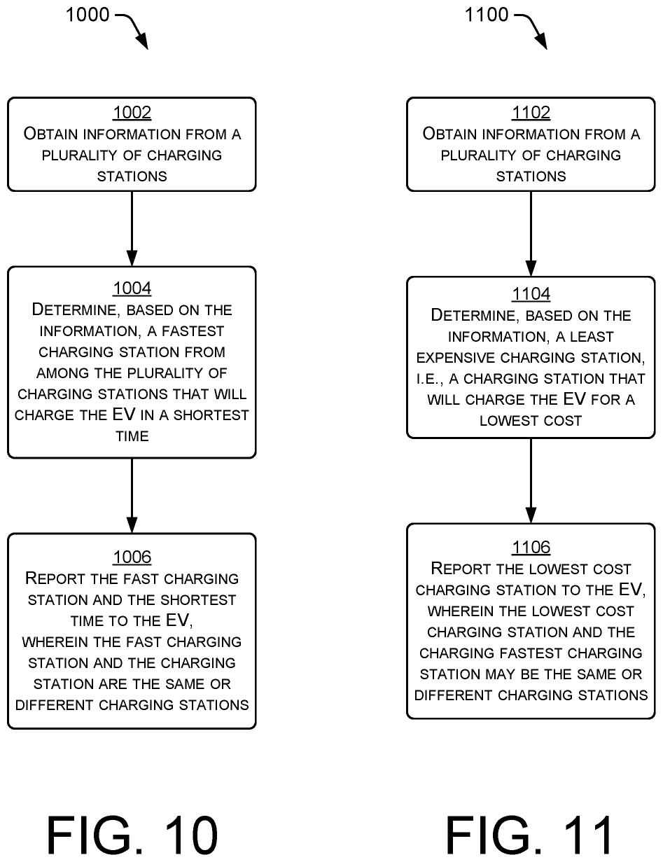

FIGS. 10 and 11 are shown separately to show how fast-charging and less expensive charging stations may be identified. However, in a typical application, the charging service 102 may consider both factors, charging time and charging expense, to identify a charging station to recommend and/or report to the EV and/or EV driver. Accordingly, charging stations are typically recommended to the EV driver based on a mixture of charging time and charging expense. In an example, the charging service 102 may recommend (to the EV and/or driver) charging stations that are above average in a ranking in both factors. In a further example, the charging service 102 may utilize a weighted function to assign relative importance to cost and time, and utilize both factors in making a recommendation of a charging station. In a still further example, an EV driver may be allowed to input to the charging service relative weights to be used for speed and cost, to thereby get the best combination for the driver. Accordingly, while FIGS. 10 and 11 are explained separately, the are typically combined in use by the charging service 102.

FIG. 10 shows example operation 1000 of a system to obtain information from a plurality of charging stations and to select a charging station that would result in a shortest time until the charge was completed, and to report the selected charging station and/or shortest charging time to the EV and/or EV driver. In the example, the operation 1000 may be performed by the charging service application 120 of FIG. 1, which may execute by operation of the charging service 102. At block 1002, information is obtained by the charging service application 120 from a plurality of charging stations. At block 1004, based on the information, a fastest charging station is determined or identified from among the plurality of charging stations, (e.g., a charging station that can result in a charged EV battery in the shortest time, e.g., based on distance of the charging station and/or charging time). At block 1006, the charging station able to charge the EV in the shortest time (and that time) is reported to the EV. In some examples, the fastest charging station and the charging station (of FIG. 9) are the same or different charging stations.

FIG. 11 shows example operation 1100 of a system to obtain information from a plurality of charging stations and to select a charging station that would result in a lowest cost to charge, and to report the selected charging station and/or the lowest cost to the EV and/or EV driver. In the example, the operation 1100 may be performed by the charging service application 120 of FIG. 1, which may execute by operation of the charging service 102. At block 1102, information is obtained by the charging service application 120 from a plurality of charging stations. Note that the information received at blocks 1002 and 1102 (of FIGS. 10 and 11, respectively) can be used to build database 308 of FIG. 3. At block 1104, based on the information (of block 1102), a least expensive charging station is determined. Typically, a charging station that will charge the EV for a lowest overall cost (e.g., energy, services, taxes, payment fees, etc.) is determined. At block 1106, the lowest cost charging station is reported to the EV. In some examples, the least expensive charging station and the charging station (of FIG. 9) are the same or different charging stations.

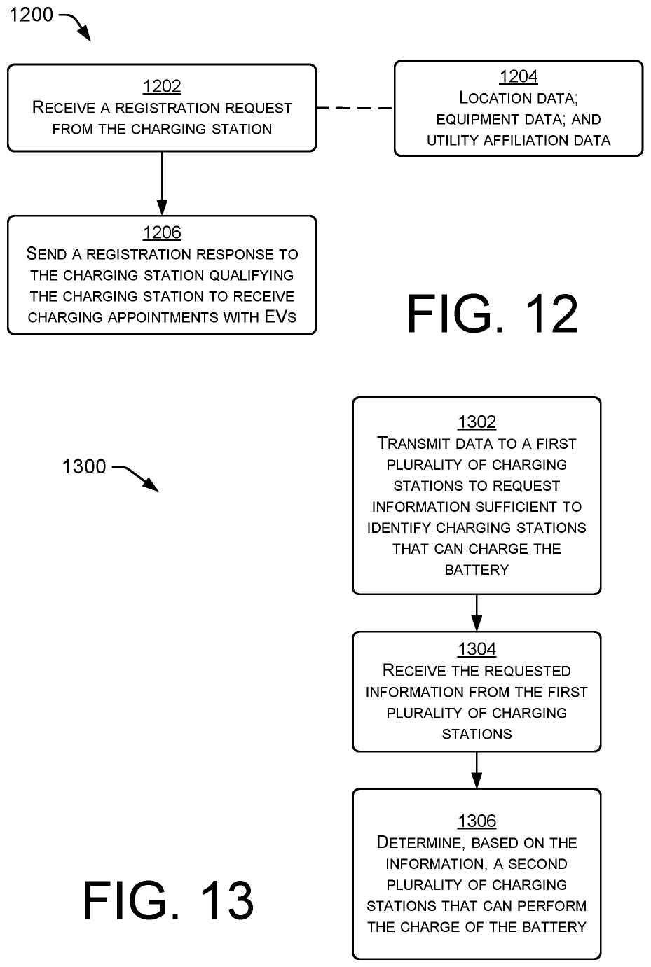

FIG. 12 shows example operation 1200 of a system to obtain information from a prospective charging station and to register (and thereby include) the prospective charging station within the logistical system for EV charging. In the example, the operation 1200 may be performed by the charging service application 120 of FIG. 1, which may execute by operation of the charging service 102. At block 1202, a registration request is received from a prospective charging station. In the example of block 1204, the data may include location data, equipment data, and/or utility affiliation data. At block 1206, a registration response is sent by the charging service application 120 to the charging station, thereby qualifying the charging station to receive charging appointments with EVs.

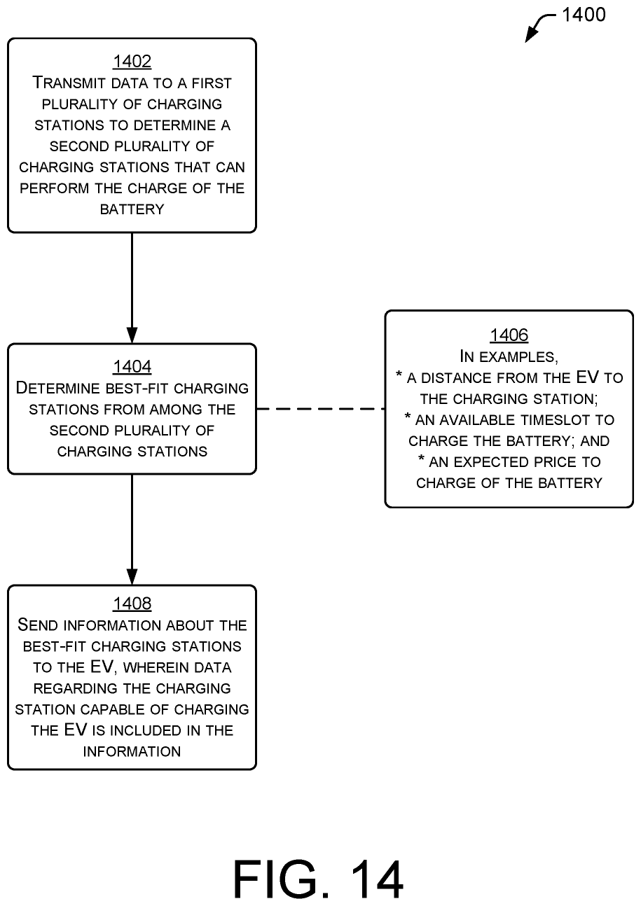

FIG. 13 shows example operation 1300 of a system to manage aspects of the operation of a charging station, including communications and interaction with a main office or other coordinating network node, website, or other entity, regarding the availability of battery-charging resources, payments, and other information. In the example, the operation 1300 may be performed by the charging service application 120 of FIG. 1, which may execute by operation of the charging service 102. The example operation 1300 provides detail on how the charging station of block 912 of FIG. 9 may be identified. The charging service application 120 asks a first plurality of charging stations (e.g., charging stations in a certain area) if they can perform the charging. From the response, the charging service application 120 identifies a second plurality of charging stations that can perform the charging. At block 1302, data is transmitted by the charging service application 120 to a first plurality of charging stations to request information sufficient to identify charging stations that can charge the battery of the EV. At block 1304, the requested information from the charging stations is received by the charging service application 120 from the first plurality of charging stations. At block 1306, the charging service application 120 determines, based on the information, a second plurality of charging stations that can perform the charge of the battery. In an example, the charging station identified by operation of FIG. 8 is one of the second plurality of charging stations.

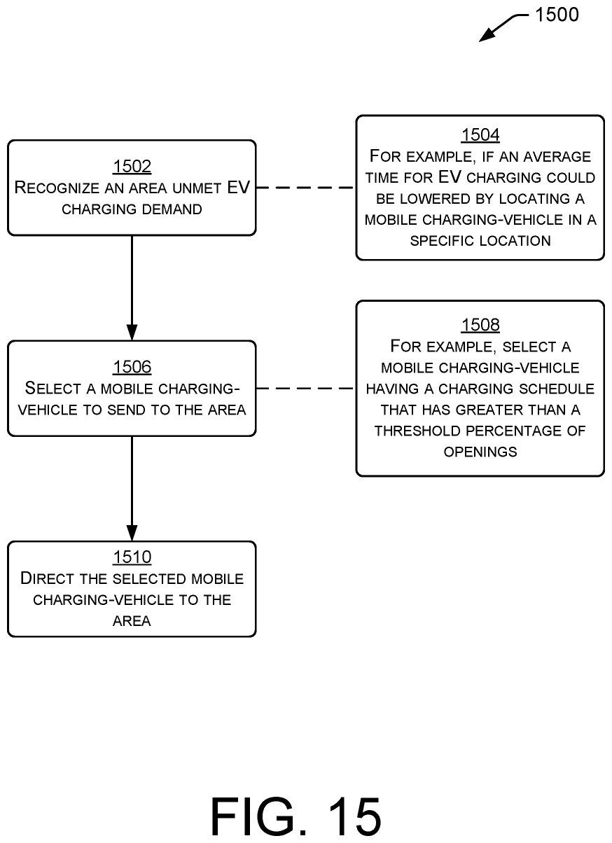

FIG. 14 shows example operation 1400 of a system to manage aspects of charging station selection by the logistical system for EV charging. In the example, the operation 1400 may be performed by the charging service application 120 of FIG. 1, which may execute by operation of a computing device of the charging service 102. At block 1402, data is transmitted (e.g., by the charging service application 120) to a first plurality of charging stations to determine a second plurality of charging stations that can perform a charge of a battery of an EV. That is, a larger group of charging stations that might be able (based on location, wait time, equipment type, etc.) to charge the EV is narrowed to a smaller group of charging stations that are able to charge the EV. At block 1404, one or more charging stations having a best-fit are determined, such as from among the second plurality of charging stations. That is, if the second group of charging stations (that are able to do the job) is large enough, the algorithm has more freedom to eliminate charging stations that are too remote, too busy, too expensive, etc. In the example of block 1406, the best-fit charging stations are selected based on one or more factors, including: a distance from the EV to the charging station; an available timeslot to charge the battery; and an expected price to charge the battery. At block 1408, information is sent by the charging service application 120 to the EV, regarding the best-fit charging stations to the EV. In an example, the data indicating the charging station(s) capable of charging the EV is included in the information, along with recommended best-fit charging stations. The information may be organized in a hierarchy based on the best-fit determination.

### Example Mobile Charging-Vehicle Operation

FIG. 15 shows an example method of operation 1500 of the logistical system for EV charging, particularly showing an example by which a mobile charging-vehicle 114 (e.g., a generator truck) may be managed, such as by a charging service application 120 of a charging service 102. In the example, the operation 1500 may be performed by the charging service application 120 of FIG. 1, which may execute by operation of a computing device of the charging service 102. The method of operation 1500 may include communicating with one or more mobile charging-vehicles, such as to direct one or more mobile charging-vehicles to change location to more efficiently charge EVs. At block 1502, an area unmet EV charging demand is recognized. In an example, the charging service application 120 may recognize a geographic area within which fewer appointment time slots are available at charging stations, and which would benefit from movement of a mobile charging-vehicle into the area. In the example of block 1504, if an average time for EV charging could be lowered by locating a mobile charging-vehicle into a specific location. At block 1506, a mobile charging-vehicle is selected to send to the area. In the example of block 1508, a mobile charging-vehicle is selected that has a charging schedule that has greater than a threshold percentage of openings. In an alternative embodiment, a mobile charging vehicle is selected that has a charging schedule that has a greater percentage of openings than an alternative mobile charging vehicle. At block 1510, the selected mobile charging-vehicle is directed to the area.

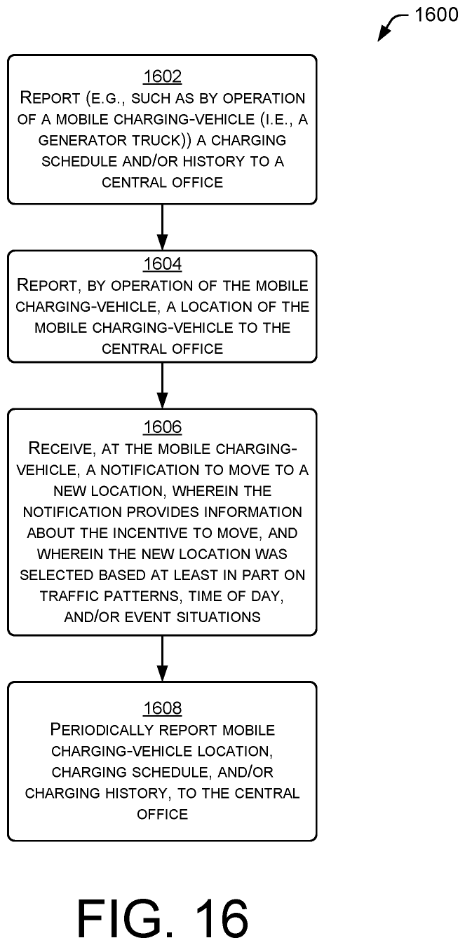

FIG. 16 shows an example method 1600 to operate a mobile charging-vehicle, and particularly showing an example of how the mobile charging-vehicle exchanges data with, and responds to, other components of the logistical system. In the example, some or all of the operations of method 1600 may be performed by the mobile charging-vehicle 114 or a mobile device of the vehicle's operator. At block 1602, a charging schedule and/or history of the mobile charging-vehicle 114 is reported to the charging service application 120 of the charging service 102. The charging schedule and/or history shows the level of activity and/or inactivity that assists the charging service application 120 to determine if the mobile charging-vehicle 114 is appropriately utilized. At block 1604, the mobile charging-vehicle 114 provides its location to the charging service application 120. The location of the mobile charging-vehicle 114 assists the charging service application 120 to determine reasonable options for repositioning the mobile charging-vehicle, assuming it is not appropriately utilized. At block 1606, a notification to move to a new location is received at the mobile charging-vehicle 114. In an example, the notification provides information about the incentive to move, such as an indication of the level of business (e.g., EV charging appointments) that could be obtained. In some examples, the new location was selected based at least in part on traffic patterns, predicted traffic patterns (e.g., based on time of day), the time of day, and/or event situations. At block 1608, the mobile charging-vehicle 114 periodically reports its location, charging schedule, and/or charging history to the charging service application 120. Such reports provide the charging service application 120 with information that can be used to direct or suggest a change in location of the mobile charging-vehicle 114. Such reports also provide insight to future EV-charging demand and particular locations.

### Example Charging Station Operation

FIG. 17 shows an example method 1700 to operate a charging station 106, including an example of how the charging station exchanges data with, and responds to, the logistical system. In the example, some or all of the operations of method 1700 may be performed by the charging station application 122 of the charging station 106 of FIG. 1. At block 1702, a charging station 106 maintains an appointment schedule showing activity of available charging equipment and anticipated EV-charging events. At block 1704, the charging station 106 responds to requests from the charging service application 120, and/or transmits without prompting, information regarding the appointment schedule and/or available battery-charging resources. Accordingly, the charging service application 120 realizes an amount of capacity or “bandwidth” available at the charging station 106. At block 1706, the charging station 106 maintains a listing of battery charging resources, and transmits information of the listing to the charging service application 120 of the charging service 102. At block 1708, the charging station 106 maintains records of payment accounts, relationships, etc., with customers, credit card companies, banks, utilities, etc., as needed for payment collection, funds transmission, etc.

### Example Systems and Devices

The following examples of a logistical system for charging electrical vehicles are expressed as numbered clauses. While the examples illustrate a number of possible configurations and techniques, they are not meant to be an exhaustive listing of the systems, methods, and/or techniques described herein.

1. A method, comprising: monitoring charge information of a battery of an electric vehicle (EV), wherein the charge information comprises at least one of energy required or power required, to perform a charge of the battery; sending first data to a charging service, wherein the first data comprises: a location of the EV; and the charge information; and receiving second data from the charging service, wherein the second data comprises: a location of a charging station capable of charging the EV; and an estimated charging time to charge the EV at the charging station.

2. The method of clause 1, wherein the second data additionally comprises: an estimated price to charge the battery of the EV.

3. The method of clause 1, wherein the estimated charging time comprises: an estimated travel time to the charging station; and an estimated time to charge the battery of the EV.

4. The method of clause 1, wherein the second data additionally comprises: an indication that a type of charging hardware required by the EV is available at the charging station.

5. The method of clause 1, additionally comprising: sending a request for a charging appointment; and receiving a reply to the request, wherein the reply indicates the location of the charging station and an appointment time.

6. The method of clause 1, additionally comprising: sending a request for a charging appointment at a specified charging station; or sending a request for a charging appointment at an unspecified charging station that is within a specified distance of a current location of the EV.

7. The method of clause 1, additionally comprising: receiving a request for at least one of a payment or an account; and responding to the request with the payment or the account.

8. The method of clause 1, additionally comprising: one or more of any of the previous clauses 1 through 7.

9. A charging service, comprising: a processor; one or more memory devices in communication with the processor; and statements, defined on the one or more memory devices, wherein the statements, when executed by the processor, perform actions comprising: receiving first data from an electric vehicle (EV), wherein the first data comprises: a location of the EV; and energy or power required to perform a charge of a battery of the EV; and sending second data to the EV, wherein the second data comprises: a location of a charging station capable of charging the EV, wherein the location of the charging station is less than a threshold distance, or less than a threshold travel time, from the location of the EV; and an estimated charging time to charge the battery of the EV at the charging station.

10. The charging service of clause 9, wherein the actions additionally comprise: sending a first message to the charging station asking for an estimated price to charge the battery of the EV, wherein the second data additionally comprises the estimated price.

11. The charging service of clause 9, wherein the actions additionally comprise: obtaining information from a plurality of charging stations; determining, based on the information, a fastest charging station from among the plurality of charging stations that will charge the EV in a shortest time; and reporting the fastest charging station and the shortest time to the EV, wherein the charging station and the fastest charging station are the same or different charging stations.

12. The charging service of clause 9, wherein the actions additionally comprise: obtaining information from a plurality of charging stations; determining, based on the information, a least expensive charging station, from among a plurality of charging stations, available to charge the EV for a lowest cost; and reporting the least expensive charging station and the lowest cost to the EV, wherein the least expensive charging station and the charging station are the same or different charging stations.

13. The charging service of clause 9, wherein the actions additionally comprise: receiving a registration request from the charging station, wherein the registration request comprises: location data; equipment data; and utility affiliation data; and sending a registration response to the charging station qualifying the charging station to receive charging appointments with EVs.

14. The charging service of clause 9, wherein the charging station is determined by actions comprising: transmitting data to a first plurality of charging stations to request information sufficient to identify charging stations that can charge the battery; receiving the information from the first plurality of charging stations; and determining, based on the information, a second plurality of charging stations that can perform the charge of the battery, wherein the charging station is one of the second plurality of charging stations.

15. The charging service of clause 9, additionally comprising: transmitting data to a first plurality of charging stations to determine a second plurality of charging stations that can perform the charge of the battery; determining best-fit charging stations from among the second plurality of charging stations, wherein best-fit is determined by inputs comprising: a distance from the EV to the charging station; an available timeslot to charge the battery; and an expected price to charge the battery; and sending information about the best-fit charging stations to the EV, wherein data regarding the charging station capable of charging the EV is included in the information.

16. The charging service of clause 9, wherein the actions additionally comprise: confirming that the battery of the EV has sufficient energy to travel to the location of the charging station.

17. The charging service of clause 9, additionally comprising: one or more of any of the previous clauses 10 through 16.

18. One or more computer-readable media storing computer-executable instructions that, when executed by one or more processors, configure a computing device to perform actions comprising: monitoring charge information of a battery of an electric vehicle (EV), wherein the charge information comprises at least one of energy required, or power required, to perform a charge of the battery; sending first data to a charging service, wherein the first data comprises: a location of the EV; and the charge information; and receiving second data from the charging service, wherein the second data is responsive to the first data, and wherein the second data comprises: a location of a charging station capable of charging the EV; and an estimated time and cost to charge the EV at the charging station.

19. The one or more computer-readable media as recited in clause 18, wherein the second data additionally comprises: an estimated price to charge the battery of the EV.

20. The one or more computer-readable media as recited in clause 18, wherein the estimated charging time comprises: an estimated travel time to the charging station; and an estimated time to charge the battery of the EV.

21. The one or more computer-readable media as recited in clause 18, wherein the second data additionally comprises: an indication that a type of charging hardware required by the EV is available at the charging station.

22. The one or more computer-readable media as recited in clause 18, wherein the actions additionally comprise: recognizing an area unmet EV charging demand; and directing a mobile charging-vehicle to the area.

23. The one or more computer-readable media as recited in clause 18, additionally comprising: one or more of any of the previous clauses 19 through 22.

### CONCLUSION

Although the subject matter has been described in language specific to structural features and/or methodological actions, it is to be understood that the subject matter defined in the appended claims is not necessarily limited to the specific features or actions described. Rather, the specific features and actions are disclosed as exemplary forms of implementing the claims.

The words comprise, comprises, and/or comprising, when used in this specification and/or claims do not preclude the presence or addition of one or more other features, devices, techniques, and/or components and/or groups thereof.

What is claimed is:

1. A method, comprising:
monitoring charge information of a battery of an electric vehicle (EV), wherein the charge information comprises at least one of energy required or power required, to perform a charge of the battery;
sending first data to a charging service, wherein the first data comprises:
a location of the EV; and
the charge information; and
receiving second data from the charging service, wherein the second data comprises:
a location of a charging station capable of charging the EV; and
an estimated charging time to charge the EV at the charging station.

2. The method of claim 1, wherein the second data additionally comprises:
an estimated price to charge the battery of the EV.

3. The method of claim 1, wherein the estimated charging time comprises:
an estimated travel time to the charging station; and
an estimated time to charge the battery of the EV.

4. The method of claim 1, wherein the second data additionally comprises:
an indication that a type of charging hardware required by the EV is available at the charging station.

5. The method of claim 1, additionally comprising:
sending a request for a charging appointment; and
receiving a reply to the request, wherein the reply indicates the location of the charging station and an appointment time.

6. The method of claim 1, additionally comprising:
sending a request for a charging appointment at a specified charging station; or
sending a request for a charging appointment at an unspecified charging station that is within a specified distance of a current location of the EV.

7. The method of claim 1, additionally comprising:
receiving a request for at least one of a payment or an account; and
responding to the request with the payment or the account.

8. A charging service, comprising:
a processor;
one or more memory devices in communication with the processor; and
statements, defined on the one or more memory devices, wherein the statements, when executed by the processor, perform actions comprising:
receiving first data from an electric vehicle (EV), wherein the first data comprises:
a location of the EV; and
energy or power required to perform a charge of a battery of the EV; and
sending second data to the EV, wherein the second data comprises:
a location of a charging station capable of charging the EV, wherein the location of the charging station is less than a threshold distance, or less than a threshold travel time, from the location of the EV; and
an estimated charging time to charge the battery of the EV at the charging station.

9. The charging service of claim 8, wherein the actions additionally comprise:
sending a first message to the charging station asking for an estimated price to charge the battery of the EV,
wherein the second data additionally comprises the estimated price.

10. The charging service of claim 8, wherein the actions additionally comprise:
obtaining information from a plurality of charging stations;
determining, based on the information, a fastest charging station from among the plurality of charging stations that will charge the EV in a shortest time; and
reporting the fastest charging station and the shortest time to the EV,
wherein the charging station and the fastest charging station are the same or different charging stations.

11. The charging service of claim 8, wherein the actions additionally comprise:
obtaining information from a plurality of charging stations;
determining, based on the information, a least expensive charging station, from among a plurality of charging stations, available to charge the EV for a lowest cost; and
reporting the least expensive charging station and the lowest cost to the EV,
wherein the least expensive charging station and the charging station are the same or different charging stations.

12. The charging service of claim 8, wherein the actions additionally comprise:
receiving a registration request from the charging station, wherein the registration request comprises:
location data;
equipment data; and
utility affiliation data; and
sending a registration response to the charging station qualifying the charging station to receive charging appointments with EVs.

13. The charging service of claim 8, wherein the charging station is determined by actions comprising:
transmitting data to a first plurality of charging stations to request information sufficient to identify charging stations that can charge the battery;
receiving the information from the first plurality of charging stations; and
determining, based on the information, a second plurality of charging stations that can perform the charge of the battery, wherein the charging station is one of the second plurality of charging stations.

14. The charging service of claim 8, additionally comprising:
transmitting data to a first plurality of charging stations to determine a second plurality of charging stations that can perform the charge of the battery;
determining best-fit charging stations from among the second plurality of charging stations, wherein best-fit is determined by inputs comprising:
a distance from the EV to the charging station;
an available timeslot to charge the battery; and
an expected price to charge the battery; and
sending information about the best-fit charging stations to the EV, wherein data regarding the charging station capable of charging the EV is included in the information.

15. The charging service of claim 8, wherein the actions additionally comprise:
confirming that the battery of the EV has sufficient energy to travel to the location of the charging station.

16. One or more computer-readable media storing computer-executable instructions that, when executed by one or more processors, configure a computing device to perform actions comprising:
monitoring charge information of a battery of an electric vehicle (EV), wherein the charge information comprises at least one of energy required, or power required, to perform a charge of the battery;
sending first data to a charging service, wherein the first data comprises:
a location of the EV; and
the charge information; and
receiving second data from the charging service, wherein the second data is responsive to the first data, and wherein the second data comprises:
a location of a charging station capable of charging the EV; and
an estimated time and cost to charge the EV at the charging station.

17. The one or more computer-readable media as recited in claim 16, wherein the second data additionally comprises:
an estimated price to charge the battery of the EV.

18. The one or more computer-readable media as recited in claim 16, wherein the estimated charging time comprises:
an estimated travel time to the charging station; and
an estimated time to charge the battery of the EV.

19. The one or more computer-readable media as recited in claim 16, wherein the second data additionally comprises:
an indication that a type of charging hardware required by the EV is available at the charging station.

20. The one or more computer-readable media as recited in claim 16, wherein the actions additionally comprise:
recognizing an area unmet EV charging demand; and
directing a mobile charging-vehicle to the area.
